(19) United States
(12) Patent Application Publication
(10) Pub. No.: US 2016/0145152 A1
(43) Pub. Date: May 26, 2016

(54) STRENGTHENED GLASS, GLASS-CERAMIC AND CERAMIC ARTICLES AND METHODS OF MAKING THE SAME THROUGH PRESSURIZED ION EXCHANGE

(71) Applicant: CORNING INCORPORATED, Corning, NY (US)

(72) Inventors: Arthur Winston Martin, Horseheads, NY (US); John Christopher Mauro, Corning, NY (US); Carlton Maurice Truesdale, Corning, NY (US)

(21) Appl. No.: 14/950,324

(22) Filed: Nov. 24, 2015

Related U.S. Application Data
(60) Provisional application No. 62/084,640, filed on Nov. 26, 2014.

(51) Int. Cl. C03C 21/00

(52) U.S. Cl. CPC C03C 21/002

(57) ABSTRACT

A method of treating a substrate is provided that includes the steps: submersing a substrate having an outer region containing a plurality of divalent exchangeable ions in a bath that comprises a polar solvent and a plurality of divalent ion-exchanging ions, the substrate comprising a glass, glass-ceramic or ceramic; pressurizing the bath to a predetermined pressure substantially above ambient pressure; and heating the bath to a predetermined temperature above ambient temperature. The method also includes a step of treating the substrate for a predetermined ion-exchange duration such that a portion of the plurality of divalent exchangeable ions is exchanged with a portion of the divalent ion-exchanging ions. In addition, the step of treating the substrate results in a greater number of divalent ion-exchanging ions entering the substrate than divalent exchangeable ions exiting the substrate.

This application claims the benefit of priority under 35 U.S.C. §119 of U.S. Provisional Application Ser. No. 62/084,640 filed on Nov. 26, 2014 the content of which is relied upon and incorporated herein by reference in its entirety.

### TECHNICAL FIELD

The present invention generally relates to strengthened glass, glass-ceramic, and ceramic articles and methods for making them for various applications including, but not limited to, substrates and touch screens for various electronic devices, e.g., mobile phones, laptop computers, book readers, hand-held video gaming systems, and automated teller machines.

### BACKGROUND

Ion-exchange processes are employed to vary and control the concentration of metal ions in various glass, glass-ceramic and ceramic substrates through localized compositional modifications. These compositional modifications in the substrates can be used to modify certain substrate properties. For example, alkali metal ions (e.g., K and Rb ions) may be imparted into surface regions of substrates as a strengthening mechanism.

These ion-exchange processes often involve the immersion of substrates in a molten salt bath at elevated temperatures. The molten salt bath includes metal ions intended to be introduced into the substrates. Ions in the substrates are exchanged with the metal ions in the bath during the ion-exchange processes.

The ability to use various ions in ion-exchange processes can be limited by the melting point of salts of these ions and the composition of the target substrate. Alkaline earth metal salts, for example, typically have high melting points far above ambient temperatures. The high melting points of these salts often exceed the stress point of the intended glass, ceramic, or glass-ceramic substrate and cannot be used. These molten salts also tend to be highly corrosive to the substrates. In addition, sufficient temperatures often cannot be reached to induce ion exchange of ions having a higher valence than alkali earth ions.

Accordingly, there is a need to develop flexible, ion-exchange systems and methods suitable for manufacturing operations that can be used to produce strengthened glass, glass-ceramic, and ceramic articles.

### SUMMARY

According to one embodiment, a method of treating a substrate is provided. The method includes the steps: submersing a substrate having an outer region containing a plurality of divalent exchangeable ions in a bath that comprises a polar solvent and a plurality of divalent ion-exchanging ions; pressurizing the bath to a predetermined pressure, wherein the predetermined pressure is substantially above ambient pressure; and heating the bath to a predetermined temperature, wherein the predetermined temperature is above ambient temperature. The method also includes a step for treating the substrate for a predetermined ion-exchange duration at the predetermined pressure and temperature such that a portion of the plurality of divalent exchangeable ions is exchanged with a portion of the ion-exchanging ions. Further, the substrate comprises a glass, glass-ceramic or ceramic.

According to an embodiment, a method of treating a substrate is provided. The method includes the steps: submersing a substrate having an outer region containing a plurality of divalent exchangeable ions in a bath that comprises a polar solvent and a plurality of ion-exchanging ions, the substrate comprising a glass, glass-ceramic or ceramic; pressurizing the bath to a predetermined pressure, wherein the predetermined pressure is substantially above ambient pressure; and heating the bath to a predetermined temperature, wherein the predetermined temperature is above ambient temperature. The method also includes the step of treating the substrate for a predetermined ion-exchange duration at the predetermined pressure and temperature such that a portion of the plurality of exchangeable ions is exchanged with a portion of the ion-exchanging ions. The plurality of divalent exchangeable ions has a first valence and the plurality of divalent ion-exchanging ions has a second valence, the first valence being greater than or equal to the second valence.

According to a further embodiment, a method of treating a substrate is provided. The method includes the steps: submersing a substrate having an outer region containing a plurality of divalent exchangeable ions in a bath that comprises a polar solvent and a plurality of divalent ion-exchanging ions, the substrate comprising a glass, glass-ceramic or ceramic; pressurizing the bath to a predetermined pressure, wherein the predetermined pressure is substantially above ambient pressure; and heating the bath to a predetermined temperature, wherein the predetermined temperature is above ambient temperature. The method also includes the step of treating the substrate for a predetermined ion-exchange duration at the predetermined pressure and temperature such that a portion of the plurality of divalent exchangeable ions is exchanged with a portion of the divalent ion-exchanging ions. Further, the step for treating the substrate results in a greater number of divalent ion-exchanging ions entering the substrate than divalent exchangeable ions exiting the substrate.

According to a further aspect of the disclosure, a strengthened article is provided that includes a substrate comprising (a) a glass, glass-ceramic or a ceramic; (b) a compressive stress region that extends to a first depth in the substrate; and (c) a bulk concentration of divalent exchangeable ions. In addition, the compressive stress region has a concentration of divalent ion-exchanged ions, a concentration of divalent exchangeable ions and a compressive stress of at least 100 MPa. Further, the concentration of divalent exchangeable ions in the compressive stress region is lower than the bulk concentration of divalent exchangeable ions.

These and other features, advantages, and objects of the present invention will be further understood and appreciated by those skilled in the art by reference to the following specification, claims, and appended drawings.

### BRIEF DESCRIPTION OF THE DRAWINGS

FIG. 1A is a schematic of an ion-exchange bath and pressure vessel employed in a system for producing ion-exchanged glass, ceramic, or glass-ceramic articles according to one embodiment.

FIG. 1B is a schematic of the system depicted in FIG. 1A with substrates immersed in the ion-exchange bath and vessel according to another embodiment.

FIG. 1C is a cross-section of one of the substrates after completion of an ion-exchange process depicted in FIG. 1B according to a further embodiment.

FIG. 2A is a graph of X-ray photoelectron spectroscopy data of a substrate, according to one embodiment.

FIG. 2B is a graph of secondary ion mass spectrometry data of a substrate according to a further embodiment.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

Discussed herein are new methods for making strengthened glass, glass-ceramic, and ceramic articles and substrates. The methods generally involve the use of a pressurized, ion-exchange process. The ion-exchange process is designed to strengthen the substrate via exposure of the substrate to alkali earth and transition metal salts dissolved in a protic or aprotic polar solvent under super atmospheric pressures and elevated temperatures. Other embodiments of the ion-exchange process may result in a net influx of ions into the glass, glass-ceramic, or ceramic substrates. In yet other embodiments, the methods can be carried out on substantially alkali-free glass, glass-ceramic and ceramic articles and substrates. In yet more embodiments, the ion-exchange process can include additional steps including washing steps or additional ion-exchange baths designed to impart additional properties to the substrate.

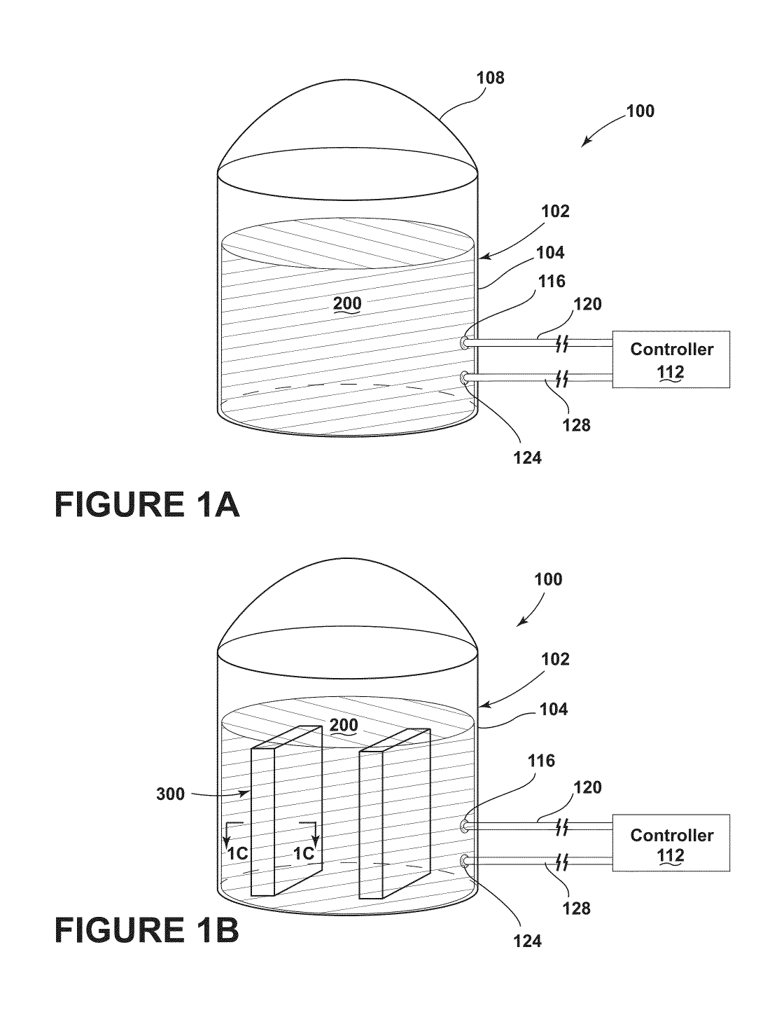

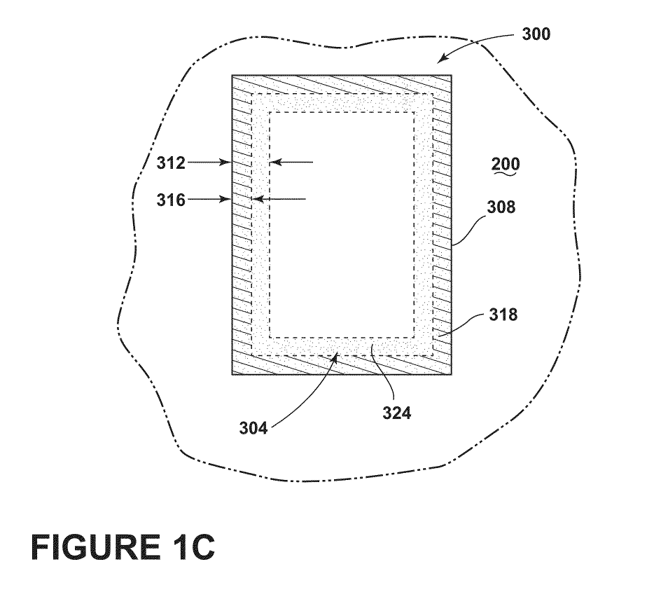

Referring to FIG. 1A, an ion-exchange system 100 for producing ion-exchanged glass, ceramic, or glass-ceramic substrates is provided. As depicted in FIG. 1A, the system 100 can comprise a pressure vessel 102 having both a pressure vessel body 104 and a pressure vessel lid 108. The vessel 102 contains an ion-exchange bath 200. The bath 200 comprises a solvent and a plurality of ion-exchanging ions, the ions being dissolved within the solvent. In one embodiment, the pressure vessel 102 can include a pressure sensor 116 and a temperature sensor 124. Both sensors can be connected to a controller 112 though a pressure coupling 120 and a temperature coupling 128, respectively. The controller 112 is capable of independently varying the temperature and the pressure within the pressure vessel 102 and the bath 200. As those with ordinary skill in the field appreciate, other equipment, systems, components, features and the like can be employed in the ion-exchange system 100 instead of the pressure vessel 102 to contain the bath 200 and perform the other functions described herein in exemplary form in connection with the vessel 102.

The solvent of ion-exchange bath 200 can comprise various solvent compositions. The solvent is preferably a polar liquid while at ambient temperature and pressure. The choice of polar solvent is not limited to particular compositions. For example, the solvent can be a protic polar solvent such as water, methanol, ethanol, isopropanol, nitromethane, formic acid, acetic acid, ethylene glycol, 1,3-propanediol, glycerol, or any other protic polar solvent or combination of protic polar solvents. Similarly, the polar solvent can also be an aprotic polar solvent such as acetone, ethyl acetate, acetonitrile, dimethyl sulfoxide, tetrahydrofuran, dimethylformamide, or any other aprotic polar solvent or combination of aprotic polar solvents. Further, the solvent may be a combination of protic and aprotic solvents in variable proportions.

The ion-exchanging ions of the ion-exchange bath 200 employed in the ion-exchange system 100 can comprise a variety of ions from a variety of sources. The ions may be introduced to the ion-exchange bath 200 from dissolution of salts, acids, and other known methods of introducing ions to a liquid. One family of salts that can be dissolved in the ion-exchange bath 200 includes metal salts. These metal salts can include salts which comprise group 2A metal ions. Such group 2A metal ions include beryllium, magnesium, calcium, strontium, barium, and radium. Exemplary salts of group 2A metal ions include sulfate, chloride, nitrate, iodide, fluoride, and bromide salts of beryllium, magnesium, calcium, strontium, barium, and radium.

Again referring to FIG. 1A, the controller 112 employed in the ion-exchange system 100 is capable of sensing the temperature and the pressure of the pressure vessel 102 and the bath 200. Controller 112 is also capable of coordinating the pressure within the pressure vessel 102 independently of the vessel temperature. Controller 112 can also perform a variety of other functions including controlling the duration at which the pressure vessel 102 and the bath 200 are kept at specific temperatures and pressures.

Referring now to FIG. 1B, substrates 300 are placed within the pressure vessel body 104 of the pressure vessel 102 employed in the ion-exchange system 100 such that the substrates 300 are submerged in the ion-exchange bath 200. In one embodiment, the pressure vessel 102 of the system 100 is capable of heating the ion-exchange bath 200 to temperatures between 50° C. and 1000° C., and more preferably to temperatures between 80° C. and 500° C. Pressure vessel 102 of the system 100 can be capable of attaining and sustaining pressures between about 0.1 MPa and about 100 MPa. In some embodiments, vessel 102 can attain and sustain pressures between about 10 MPa and about 75 MPa. The pressure vessel 102 is capable of accepting substrates 300 of varying size and physical attributes. In one exemplary embodiment, the pressure vessel 102 is capable of accepting glass panels approximately 3.4 ft×4 ft. In another exemplary embodiment, the pressure vessel 102 is designed to accept glass panels approximately 6 ft×7 ft. In yet another embodiment, the pressure vessel 102 is capable of receiving multiple substrates 300 of different sizes and configurations. The design of the pressure vessel 102 is scalable in size and shape. Therefore, the pressure vessel 102 can be configured to fit various sizes and configurations of substrate 300 without appreciable loss of pressure or temperature in the bath 200 employed by system 100.

In one embodiment, the ion-exchange bath 200 employed in the ion-exchange system 100 is prepared within the pressure vessel 102 prior to its use. In another embodiment, the ion-exchange bath 200 is prepared remotely from the pressure vessel 102 and is pumped or similarly conveyed into the vessel 102 at an appropriate time. In yet other embodiments, the ion-exchange bath 200 can be reused in the same vessel 102 or can be transferred to a different pressure vessel to carry out a similar ion-exchange on a different substrate 300 or group of substrates 300.

Referring to FIG. 1B again, the substrate 300 can consist essentially of a glass, glass-ceramic, or ceramic composition. The choice of glass used for the substrate 300 is not limited to a particular composition, as ion-exchange properties can be obtained using a variety of glass compositions. For example, the composition chosen can be any of a wide range of silicate, borosilicate, aluminosilicate, boroaluminosilicate, or soda lime glass compositions, which optionally can comprise one or more alkaline earth modifiers. In one embodiment, the composition of the substrate 300 may be substantially free of group 1A alkali elements. In another embodiment, alkaline earth ions, transition metal ions, and metalloid ions may be added to the substrate 300 composition for the specific purpose of serving as a divalent exchangeable ion during the ion-exchange process. In another embodiment, the weight or atomic percentage of an ion that is already present in the selected composition may be increased so as to act as a source of divalent exchangeable ions for the ion-exchange process.

By way of illustration, one family of compositions that may be employed in the glass, ceramic, or glass-ceramic substrate 300 includes those having at least one of aluminum oxide or boron oxide and at least one of an alkali metal oxide or an alkali earth metal oxide, wherein −15 mol %≦(R₂O+R₂O−Al₂O₃−ZrO₂)−B₂O₃≦4 mol %, where R can be Li, Na, K, Rb, and/or Cs, and R₂ can be Mg, Ca, Sr, and/or Ba. One subset of this family of compositions includes from about 62 mol % to about 70 mol % SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. Such glasses are described more fully in U.S. patent application Ser. No. 12/277,573, hereby incorporated by reference in its entirety as if fully set forth below.

Another illustrative family of compositions that may be employed in glass, ceramic, or glass-ceramic substrate 300 includes those having at least 50 mol % SiO₂ and at least one modifier selected from the group consisting of alkali metal oxides and alkaline earth metal oxides, wherein [(Al₂O₃(mol %)+B₂O₃(mol %))/(Σ alkali metal modifiers (mol %))]>1. One subset of this family includes from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. Such glasses are described in more fully in U.S. patent application Ser. No. 12/858,490, hereby incorporated by reference in its entirety as if fully set forth below.

Yet another illustrative family of compositions that may be employed in glass, ceramic, or glass-ceramic substrate 300 includes those having SiO₂, Al₂O₃, P₂O₅, and at least one alkali metal oxide (R₂O), wherein 0.75≦[(P₂O₅(mol %)+R₂O(mol %))/M₂O₃(mol %)]≦1.2, where M₂O₃=Al₂O₃+B₂O₃. One subset of this family of compositions includes from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O. Another subset of this family of compositions includes from about 40 mol % to about 64 mol % SiO₂; from 0 mol % to about 8 mol % B₂O₃; from about 16 mol % to about 28 mol % Al₂O₃; from about 2 mol % to about 12 mol % P₂O₅; and from about 12 mol % to about 16 mol % R₂O. Such glasses are described more fully in U.S. patent application Ser. No. 13/305,271, hereby incorporated by reference in its entirety as if fully set forth below.

Yet another illustrative family of compositions that can be employed in glass, ceramic, or glass-ceramic substrate 300 includes those having at least about 4 mol % P₂O₅, wherein (M₂O₃(mol %)/RₓO(mol %))<1, wherein M₂O₃=Al₂O₃+B₂O₃, and wherein RₓO is the sum of monovalent and divalent cation oxides present in the glass. The monovalent and divalent cation oxides can be selected from the group consisting of Li₂O, Na₂O, K₂O, Rb₂O, Cs₂O, MgO, CaO, SrO, BaO, and ZnO. One subset of this family of compositions includes glasses having 0 mol % B₂O₃. Such glasses are more fully described in U.S. Provisional Patent Application No. 61/560,434, the content of which is hereby incorporated by reference in its entirety as if fully set forth below.

Still another illustrative family of compositions that can be employed in a glass, ceramic, or glass-ceramic substrate 300 includes those having Al₂O₃, B₂O₃, alkali metal oxides, and contains boron cations having three-fold coordination. When ion-exchanged, these glasses can have a Vickers crack initiation threshold of at least about 30 kilograms force (kgf). One subset of this family of compositions includes at least about 50 mol % SiO₂; at least about 10 mol % R₂O, wherein R₂O comprises Na₂O; Al₂O₃, wherein −0.5 mol %≦Al₂O₃(mol %)−R₂O(mol %)≦2 mol %; and B₂O₃, and wherein B₂O₃(mol %)−(R₂O(mol %)−Al₂O₃(mol %))≦4.5 mol %. Another subset of this family of compositions includes at least about 50 mol % SiO₂, from about 9 mol % to about 22 mol % Al₂O₃; from about 4.5 mol % to about 10 mol % B₂O₃; from about 10 mol % to about 20 mol % Na₂O; from 0 mol % to about 5 mol % K₂O; at least about 0.1 mol % MgO and/or ZnO, wherein 0≦MgO+ZnO 6 mol %; and, optionally, at least one of CaO, BaO, and SrO, wherein 0 mol %≦CaO+SrO+BaO≦2 mol %. Such glasses are more fully described in U.S. Provisional Patent Application No. 61/653,485, the content of which is incorporated herein by reference in its entirety as if fully set forth below.

Still another illustrative composition that can be employed in a glass, ceramic, or glass-ceramic substrate 300 includes about 50 mol % to about 80 mol % SiO₂; about 2 mol % to about 20 mol % Al₂O₃; about 0 mol % to about 35 mol % B₂O₃; about 0 mol % to about 0.5 mol % of a group consisting of Li₂O, Na₂O, K₂O; about 0 mol % to about 10 mol % of MgO; about 0 mol % to about 25 mol % of CaO; about 0 mol % to about 10 mol % of SrO; about 0 mol % to about 10 mol % of BaO; about 0 mol % to about 0.5 mol % of each of Fe₂O₃, As₂O₃, Sb₂O₃; about 0 mol % to about 0.1 mol % of ZrO₂; and greater than about 6 Mol % of a combination of MgO, CaO, SrO.

Still another illustrative composition that can be employed in a glass, ceramic, or glass-ceramic substrate 300 includes about 60 mol % to about 70 mol % SiO₂; about 5 mol % to about 15 mol % Al₂O₃; about 5 mol % to about 25 mol % B₂O₃; about 0 mol % to about 0.25 mol % of a group consisting of Li₂O, Na₂O, K₂O; about 0 mol % to about 5 mol % of MgO; about 2 mol % to about 18 mol % of CaO; about 0 mol % to about 5 mol % of SrO; about 0 mol % to about 5 mol % of BaO; about 0 mol % to about 0.2 mol % of each of Fe₂O₃, As₂O₃, Sb₂O₃; about 0 mol % to about 0.1 mol % of ZrO₂; and greater than about 6 Mol % of a combination of MgO, CaO, SrO.

As used herein, a liquid above its boiling temperature at ambient pressure is said to be “superheated.” Polar solvents, such as water, employed in an exemplary embodiment of the ion-exchange system 100, can experience a change in the intermolecular forces which induces changes in the properties of the liquid. For example, a polar liquid can exhibit properties closer to that of an organic solvent. In another example, the superheated liquid has a viscosity that approaches zero as it approaches the critical temperature. By conducting the ion-exchange process within the pressure vessel 102 of system 100, these relationships can be exploited to obtain both manufacturing and product advantages.

Still referring to FIG. 1B, an exemplary ion-exchange treatment method includes a step of preparing an ion-exchange bath (e.g., bath 200) with a bath composition that comprises a polar solvent and a plurality of divalent ion-exchanging ions. In some embodiments, the bath is prepared in a vessel, container, receptacle or other system (e.g., vessel 102). The method also includes a step of submersing a substrate (e.g., substrate 300) having an outer region containing a plurality of divalent exchangeable ions in the bath. The method then includes steps of pressurizing the bath to a predetermined pressure substantially above ambient pressure; and heating the bath to a predetermined temperature (typically, the bath is heated to above ambient temperatures) and treating the substrate for a predetermined ion-exchange duration at the predetermined pressure and temperature such that a portion of the plurality of divalent exchangeable ions is exchanged with a portion of the divalent ion-exchanging ions. In some embodiments of the method, the predetermined ion-exchange duration, temperature and pressure can each be selected based at least in part on the substrate composition and the bath composition.

According to some embodiments, the ion-exchange method employing system 100 can be conducted for a predetermined time based on the composition of the bath 200, temperature of the bath 200, composition of the substrate 300, the pressure in the vessel 102 and/or the concentration or type of the divalent exchangeable ions in the substrate 300. In yet other embodiments, the ion-exchange duration, bath temperature, and the pressure can be predetermined to define an ion-exchange region 324 within the substrate 300. The ion-exchange region 324 is defined as the region between the substrate first surface 308 and the substrate first selected depth 312. The substrate first selected depth 312 can be at or above the depth limit of the substrate outer region 304. The substrate outer region 304 is the area within which divalent exchangeable ions of the substrate 300 are exchangeable with the divalent ion-exchanging ions of the ion-exchange bath 200 during the ion-exchange process employing the system 100. Further, the substrate ion-exchange region 324 is the area in substrate 300 where ions have been exchanged up through the first selected depth 312.

Referring to FIGS. 1B and 1C, in an exemplary embodiment, substrate 300 can comprise a silicate glass composition having divalent exchangeable metal, metalloid and non-metal ions. The ions are exchangeable in the sense that exposure of the substrate 300 and substrate first surface 308 to the ion-exchange bath 200 containing divalent ion-exchanging ions can result in the exchange of some of the divalent exchangeable ions in the substrate 300 with the divalent ion-exchanging ions from the bath 200. It should be understood that the divalent exchangeable ions are not necessarily divalent, only that they are exchangeable for ions that are divalent. For example, divalent exchangeable ions may have a valence of three, four, or five, but are still be capable of exchange with a divalent ion-exchanging ion. During the exchange, a plurality of divalent exchangeable ions from the substrate 300 exchange through the substrate first surface 308 with a plurality of divalent ion-exchanging ions in the bath 200. The divalent ion-exchanging ions exchange from the bath 200 into the substrate 300 to a first selected depth 312 thereby forming a substrate ion-exchange region 324 within the substrate outer region 304. In some embodiments, the ion-exchange process employed in the ion-exchange system 100 can comprise multiple ion-exchange steps performed on substrate 300. During additional ion-exchange processes (e.g., with a second bath 200 at a different pressure, time and duration), the divalent ion-exchanging ions of the bath 200 may exchange into the substrate 300 deeper than, or shallower than, previous ion-exchange processes. In such embodiments, the first selected depth 312 is the inner bound for the deepest diffusing ion-exchange process.

The diffusion depth of the divalent ion-exchanging ions (e.g., to the first selected depth 312) can be referred to as the depth of layer (“DOL”). The DOL of substrates 300 ion-exchanged with system 100 may be about 15 μm or greater. In some instances, the DOL may be in the range from about 15 μm to about 50 μm, from about 20 μm to about 45 μm, or from about 30 μm to about 40 μm. In some embodiments, the DOL of substrate 300 can be dependent on the composition of the substrate 300 and/or the bath 200. In other embodiments, the DOL may also be dependent on the ion-exchange process conditions, such as temperature and pressure, within the pressure vessel 102 employed in the ion-exchange system 100.

In one or more embodiments, compressive stress levels are developed in the ion-exchange region 324 (see FIG. 1C). Compressive stresses are developed during the ion-exchange process in which a plurality of divalent exchangeable ions in substrate 300, and specifically ions contained between the substrate first selected depth 312 and the substrate first surface 308, is exchanged with a plurality of divalent ion-exchanging ions having an ionic radius larger than the plurality of the divalent exchangeable metal ions. In addition to having larger ionic radii, the number of divalent ion-exchanging ions entering the substrate 300 may be greater than the number of divalent exchangeable ions leaving the substrate 300 leading to a net influx of ions into the substrate 300. The net influx of ions into the substrate 300 may also assist in the development of appreciable compressive stress levels within the substrate 300. As a result, the ion-exchange region 324 of the substrate 300 comprises the plurality of the divalent ion-exchanging ions and exhibits measurable compressive stress levels. The divalent exchangeable ions may be alkali earth metal ions such as beryllium, magnesium, calcium, strontium, barium, and radium. In addition, the exchangeable ions may include transition metals and non-metals such as manganese, iron, zinc, cadmium, boron, aluminum, gallium, and indium with the proviso that the divalent ion-exchanging ions have an ionic radius greater than the ionic radius of the divalent exchangeable ions.

During ion-exchange, the substrate 300 and the bath 200 typically maintain charge neutrality and therefore the valence of both the divalent exchangeable ions (initially in the substrate) and the divalent ion-exchanging ions (initially in the bath) is relevant. In order to maintain charge neutrality, the total charge or valence of the divalent exchangeable ions exiting the substrate 300 must equal that of the divalent ion-exchanging ions entering the substrate from the bath 200.

By employing a divalent ion-exchanging ion with a different valence than that of the intended divalent exchangeable ion, a net influx or outflux of ions to/from the substrate 300 can be controlled. For example, an embodiment of this disclosure designates the divalent ion-exchanging ions as barium ions having a valence of 2 and the divalent exchangeable ions (initially in the substrate) are boron ions having a valence of 3. In order to maintain charge neutrality within the substrate 300, three barium ions must be exchanged into the substrate 300 for every two boron ions exchanged out of the substrate 300. Consequently, this exchange results in a net influx of ions into the substrate 300. This process is advantageous not only because it may exchange ions having a larger ionic radius into the substrate 300, but it also results in a net increase in the number of ions disposed within the substrate 300. As a result of the ion-exchange process, the concentration of divalent ion-exchanging ions in the ion-exchange region 324 is greater than the concentration of divalent exchangeable ions in the bulk of the substrate 300. Moreover, the concentration of divalent exchangeable ions in the bulk of the substrate is higher than the concentration of the divalent exchangeable ions in the ion-exchange region.

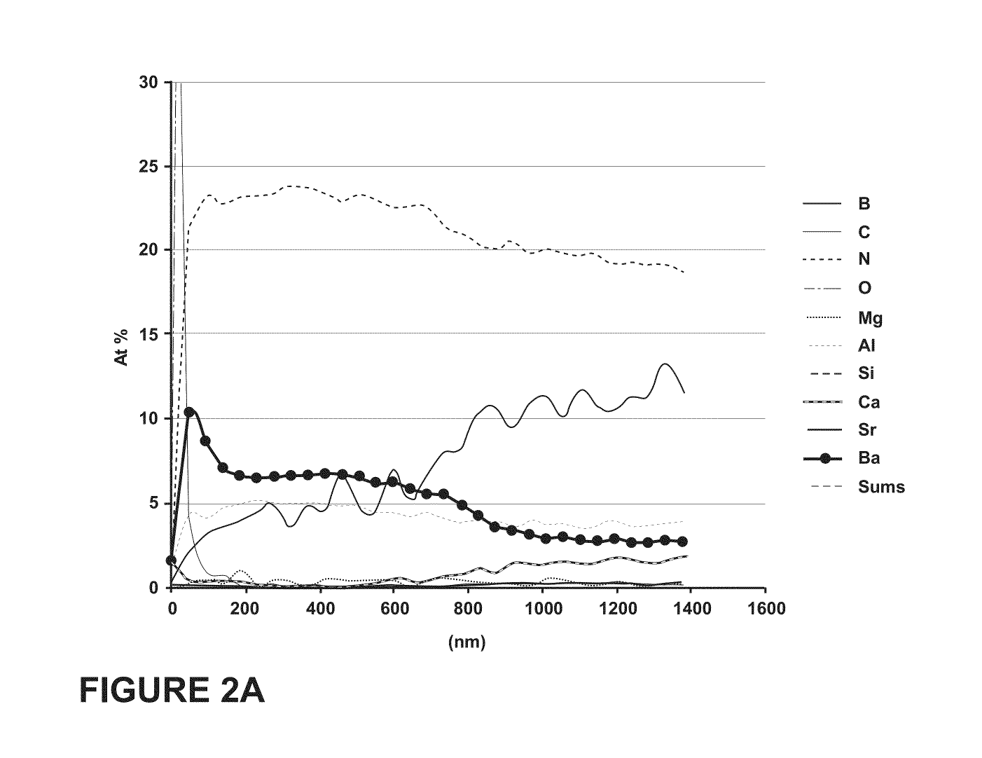

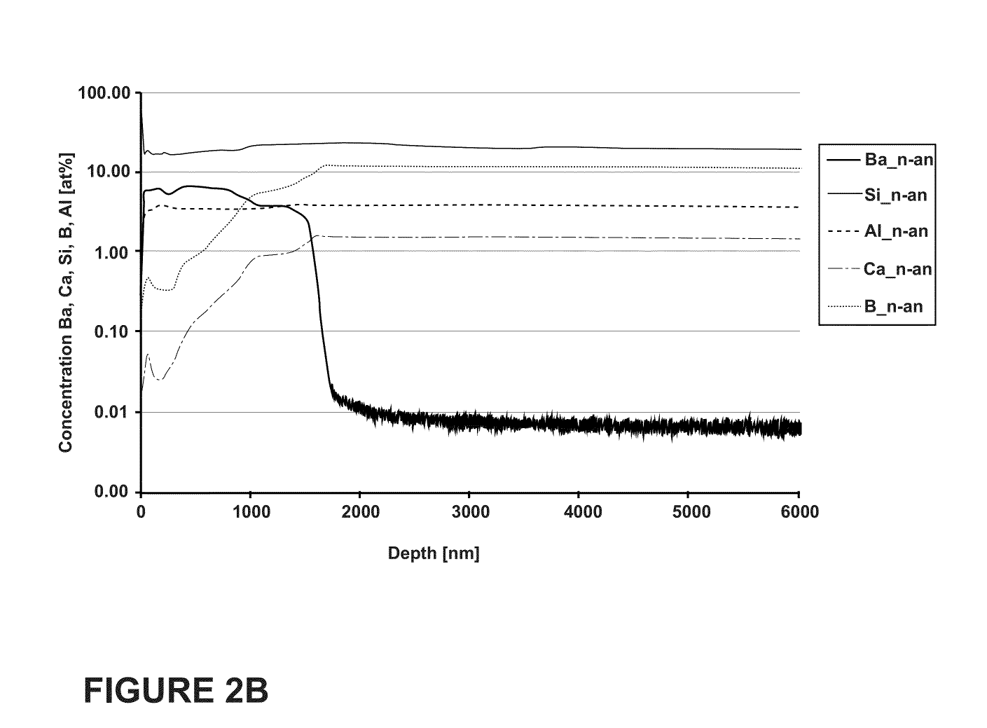

Referring now to FIGS. 2A and 2B, graphs are depicted that show the concentrations of elements within a substrate having a calcium-rich, alkali-free boroaluminosilicate glass composition subjected to an ion-exchange process according to an embodiment of this disclosure. In particular, the glass substrate was exposed to a barium nitrate solution at 330° C. in a pressure vessel at a pressure of 45 MPa for 3 hours. Specifically, FIG. 2A is an x-ray photoelectron spectroscopy (XPS) profile and FIG. 2B is a secondary ion mass spectrometry (SIMS) profile indicating concentrations of elements (in atom %) vs. depth (nm) within the sample. These measurements were made by probing a 0.5 mm×0.5 mm area at the center of within the center of a 2 mm×2 mm sputtered area. The sputtering was conducted with argon ions at 4 kV at 15 mA. The pass energy was set at 93 eV.

In the depicted sample profiles shown in FIGS. 2A and 2B, the divalent ion-exchanging ions substantially comprise barium and the divalent exchangeable ions include calcium and boron. As can be seen, the concentration of barium within the outer ion-exchanged region of the sample (to a depth of about 800-1000 nm) is elevated relative to the concentration of barium in the bulk (at depths greater than 1000 nm). Likewise, the concentrations of calcium and boron within the sample are depleted in the ion-exchange region in comparison to the bulk of the sample. This inverse relationship between barium, acting as a divalent ion-exchanging ion, and calcium and boron, acting as divalent exchangeable ions, suggests that the calcium and boron ions of the sample have been exchanged for the barium ions of the ion-exchange process.

Referring back to FIGS. 1B and 1C, as some of the divalent ion-exchanging ions from the bath 200 are distributed and otherwise incorporated into the substrate 300 at the expense of some of the divalent exchangeable ions originally in the substrate 300, a compressive stress layer 318 develops in the substrate 300 within the ion-exchange region 324. The compressive stress layer 318 extends from the substrate first surface 308 to a substrate compressive layer depth 316. In some embodiments, the compressive stress layer 318 can have a depth 316 above the substrate first selected depth 312, yet in other embodiments the depth 316 can be at the first selected depth 312. In some aspects, any differences between the first selected depth 312 and the depth 316 can be attributed to the presence of a low concentration of ion-exchanging ions (i.e., in the region of the substrate 300 between the first depth 312 and the depth 316, as depicted in FIG. 1C) that does not otherwise contribute to an appreciable level of compressive stress.

In general, an appreciable concentration of the divalent ion-exchanging ions from the strengthening bath 200 (e.g., Ba⁺ ions) exists in the compressive stress layer 318 of the substrate 300 after its submersion in the strengthening bath 200. These divalent ion-exchanging ions are generally larger in radius than the divalent exchangeable ions (e.g., Ca⁺ or B⁺ ions), thereby increasing the compressive stress level in the ion-exchange region 324 within the substrate 300. In addition, the amount of compressive stress associated with the compressive stress layer 318 and the depth of the substrate compressive layer depth 316 can each be varied (by virtue of the ion-exchange process conditions employed in system 100, for example) based on the intended use of the substrate 300. In some embodiments, the compressive stress level in the compressive stress layer 318 is controlled such that tensile stresses generated within the substrate 300 as a result of the compressive stress layer 318 do not become excessive to the point of rendering the substrate 300 frangible. In some embodiments, the compressive stress level in the layer 318 may be about 100 MPa or greater. Even more preferably, the compressive stress level is 200 MPa or greater. For example, the compressive stress level in the layer 318 may be up to about 700 MPa, about 800 MPa, about 900 MPa, or even about 1000 MPa.

Still referring to FIGS. 1B and 1C, in some embodiments, the system 100 and the pressure vessel 102 (or another container, receptacle, system that can perform the same or similar function) are capable of performing multiple step ion-exchanges or multiple ion-exchange processes on a single substrate 300 or a group of substrates 300. In some embodiments, the multi-step processes include additional strengthening treatments at different pressures and temperatures or treatments with different strengthening baths. In other embodiments, the additional ion-exchanges employing system 100 can include the creation of new layers such as an antimicrobial region through an antimicrobial ion-exchange process.

In order to initiate ion-exchange using the ion-exchange system 100, an ion-exchange activation energy barrier must be overcome to allow divalent exchangeable ions and divalent ion-exchanging ions to migrate in and out of the ion-exchange bath 200 and the substrate 300. Both temperature and pressure can serve as an energy source to overcome the activation energy; however, some nominal increased temperature is typically required. According to some embodiments, an ion-exchange process employing system 100 can be carried out below the atmospheric boiling point of the ion-exchange bath 200 at a super-atmospheric pressure. In other embodiments, the ion-exchange process can be carried out with the temperature of the ion-exchange bath 200 set below the stress point of the substrate 300 at a super-atmospheric pressure. In such embodiments, the pressure of the bath 200 can be between 0.16 MPa and 100 MPa and, more particularly, between 10 MPa and 75 MPa. In these exemplary embodiments both the temperature and the pressure of the bath 200 employed in system 100 may provide the activation energy to initiate ion-exchange between the bath 200 and the substrate 300. One advantage of using the ion-exchange system 100 at a super-atmospheric pressure is that the temperature of the ion-exchange bath 200 can be minimized without appreciably increasing the process duration.

In some embodiments, the reduction in the temperature of the bath 200 allows the substrate 300 to be configured with a functional or decorative layer that is sensitive to heat. Exemplary functional layers include, but are not limited to, touch screen patterning, scratch resistant coatings, and other protective features for use in consumer electronics. Another advantage that can be realized from these embodiments of system 100 is a decrease in production costs associated with the lower temperatures needed for the ion exchange step(s).

In some embodiments, the divalent ion-exchanging ions of the ion-exchange bath 200 comprise ions from high melting temperature salts as determined relative to the stress point of the composition of the substrate 300. In further embodiments, the divalent ion-exchanging ions in the ion-exchange bath 200 may be derived at least in part from salts having a melting temperature above 400° C. In other embodiments, the melting temperature of the divalent ion-exchange salts is above the stress point of the substrate 300 (e.g., having a glass, glass-ceramic, or ceramic composition) being ion-exchanged in system 100. One advantage from dissolving divalent ion-exchanging salts in polar solvents according to aspects of the disclosure is that temperatures high enough to damage the substrate 300 are not required during the ion-exchange process employed in ion-exchange system 100. The dissolution of the divalent ion-exchanging salts in the solvent of the bath 200 allows free ions to make contact with the substrate outer region 304 at temperatures lower than the melting point of the salt. Therefore, the ion-exchange bath 200 can employ salts with melting temperatures higher than the stress point of the substrate 300 that is being ion-exchanged. Exemplary high temperature salt families that may be used in the ion-exchange process of ion-exchange system 100 include group 2A alkali metal salts and transition metal salts.

In other embodiments, the ion-exchange system 100 can employ a pressure vessel 102 (or another container, receptacle, system that can perform the same or similar function) that includes an ion-exchange bath 200 comprising a high critical point solvent and a substrate 300 with a glass composition having a high stress point. Arranged in this fashion, the system 100 can be used to employ pressure vessel 102 for conducting the ion exchange at a temperature above 400° C. and a pressure above 40 MPa. In such embodiments, the duration of the ion-exchange can be shortened due to an increased ion-exchange rate resulting from the high temperatures and pressures.

In another aspect, the initiation of the ion-exchange process in ion-exchange system 100 can be governed by the concentration of salts in the bath 200 and the magnitude of the concentration gradient between the bath 200 and the substrate 300. In some embodiments, the concentration of salts in the ion-exchange bath 200 can range from unsaturated to supersaturated at ambient temperature, and more particularly from saturated to supersaturated at ambient temperature. In other embodiments, the salt concentration in the ion-exchange bath 200 can be supersaturated at ambient temperatures and pressures, but saturated at the predetermined processing temperatures and pressures. One advantage of the ion-exchange bath 200 reaching a superheated state is the increased capability of the ion-exchange bath 200 to carry dissolved ions. Another advantage of the superheated ion-exchange bath 200 is that a salt having low solubility in the solvent at ambient temperatures may have high solubility in the superheated state. The increased ability to hold solute ions creates a greater concentration gradient between the ion-exchange bath 200 and the substrate 300. This increased concentration gradient can positively affect the exchange rate between the substrate 300 and the ion-exchange bath 200, thereby shortening the duration required to develop a predetermined or desired first depth 312 and ion-exchange region 324.

In one exemplary embodiment, the pressure vessel 102 (or another container, receptacle, system that can perform the same or similar function) employed in ion-exchange system 100 is capable of recycling the ion-exchange bath 200, including both the polar solvent and the divalent ion-exchange salts. A superheated solvent (e.g., heated during an ion-exchange step) can be recycled for use in a washing step as a washing liquid to wash excess and deposited salts from the surface of the substrate 300. In another embodiment, the superheated solvent can be screened or filtered prior to the washing step to increase the cleanliness of the substrate 300. In such embodiments, the filtered salts can be reintroduced in later ion-exchanges to reduce material costs. Such a washing step saves processing time by eliminating the need to transfer the substrate 300 to a separate cleaning line. The washing step also minimizes energy and material use by eliminating the need to heat another solvent for use in the washing step. In another embodiment, the washing liquid can be recycled and used again as an ion-exchange bath 200 in system 100 until the percentage of desired divalent ion-exchanging ions falls below a predetermined minimum value.

### Examples

Table 1 lists compressive stress levels measured in various substrates having the same base glass composition (i.e., a calcium-rich, alkali-free boroaluminosilicate glass composition) after being subjected to an ion-exchange process consistent with aspects of the disclosure. In particular, the ion-exchange process was performed using different barium halides for different times. The Sample IDs labeled “Ba-CS1” were subjected to an ion-exchange process using an aqueous bath with barium iodide (200 g/200 ml water) at 330° C. for 6 hours. The Sample ID labeled “Ba-CS2” was subjected to an ion-exchange process with the same barium iodide solution and carried out at 330° C. for 3 hours. The sample IDs labeled “BaBr-CS2” were subjected to an ion-exchange process that was carried out at 330° C. for 3 hours with a barium bromide aqueous solution (50 g/100 ml water). Further, the sample ID labeled “BaCl-CSX” was subjected to an ion-exchange process that was carried out at 330° C. for 4 hours with a barium chloride aqueous solution (100 g/200 ml water).

For all of the samples used to generate the data in Table 1 below, the ion-exchange process was carried out in a 60 ml reactor chamber (e.g., system 100). Samples (e.g., substrates 300) were loaded into the reactor chamber in an interlayered fashion. After the samples were placed within the reaction chamber, at least 50 ml of a solution (e.g., ion-exchange bath 200) was injected into the reaction chamber such that the samples were immersed. The solution of barium iodide, barium chloride, or barium bromide was then added to the reaction chamber, with the concentrations of these solutions as outlined earlier and as listed in Table 1. After the solutions were injected, the reaction chamber was closed, heated to 330° C., pressurized to 45 MPa, and allowed to soak for the prescribed period of time. After the prescribed period of time, the reactor was allowed to cool to 60° C. within one hour, at which point the samples were removed and washed to remove residual salts.

The compressive stress (MPa) and depth of layer (DOL) levels for the samples set forth in Table 1 were determined in accordance with conventional optical techniques. It is evident from the data that compressive stress levels of over 100 MPa at a DOL of at least 3 μm can be realized by exposing glass substrates to aqueous barium halide salt aqueous solutions at above ambient pressures. Notably, the samples subjected to barium bromide solutions developed compressive stress levels in excess of 200 MPa with a DOL of 3.5 μm or greater.

TABLE 1
Compressive stress levels in glass substrates exposed to Ba halides

| | | | | | | | Depth |
|---|---|---|---|---|---|---|---|
| | | | | | | | of |
| Sample | Location | Index | Base | | | Compressive | Layer |
| ID | Measured | Oil | Glass | Temperature/Time | SOC | Stress (MPa) | (μ) |
| Bal- | Center | 1.73 | 700YB | 330° C./6 Hours | 43.53 | 149.321 | 4.722 |
| CS1 | | | | | | | |
| Bal- | Edge 1 | 1.73 | 700YB | 330° C./6 Hours | 43.53 | 140.922 | 5.629 |
| CS1 | | | | | | | |
| Bal- | Edge 2 | 1.73 | 700YB | 330° C./6 Hours | 43.53 | 196.626 | 3.933 |
| CS1 | | | | | | | |
| Bal- | Edge 2 | 1.48 | 700YB | 330° C./3 Hours | 43.53 | 207.619 | 3.521 |
| CS2 | | | | | | | |
| BaBr- | Edge 2 | 1.73 | 700YB | 330° C./3 Hours | 43.53 | 209.24 | 3.843 |
| CS2 | | | | | | | |
| BaBr- | Center | 1.48 | 700YB | 330° C./3 Hours | 43.53 | 223.324 | 3.408 |
| CS2 | | | | | | | |
| BaBr- | Edge 2 | 1.48 | 700YB | 330° C./3 Hours | 43.53 | 154.092 | 3.962 |
| CS2 | | | | | | | |
| BaCl- | Edge 1 | 1.48 | 700YB | 330° C./4 Hours | 43.53 | 202.212 | 3.504 |
| CSX | | | | | | | |

While the embodiments disclosed herein have been set forth for the purpose of illustration, the foregoing description should not be deemed to be a limitation on the scope of the disclosure or the appended claims. It will be apparent to those skilled in the art that various modifications and variations can be made without departing from the spirit or scope of the claims.

What is claimed is:

1. A method of treating a substrate, comprising the steps:
submersing a substrate having an outer region containing a plurality of divalent exchangeable ions in a bath that comprises a polar solvent and a plurality of divalent ion-exchanging ions;
pressurizing the bath to a predetermined pressure, wherein the predetermined pressure is substantially above ambient pressure;
heating the bath to a predetermined temperature, wherein the predetermined temperature is above ambient temperature; and
treating the substrate for a predetermined ion-exchange duration at the predetermined pressure and temperature such that a portion of the plurality of divalent exchangeable ions is exchanged with a portion of the ion-exchanging ions, and
wherein the substrate comprises a glass, glass-ceramic or ceramic.

2. The method according to claim 1, wherein the step for treating the substrate is further conducted to define a divalent ion-exchange region in the outer region that extends from a first surface to a first selected depth in the substrate.

3. The method according to claim 1, wherein the predetermined pressure is approximately 10 MPa to 75 MPa.

4. The method according to claim 1, wherein the predetermined temperature is set at approximately 200° C. to 350° C.

5. The method according to claim 1, wherein the polar solvent is a protic polar solvent selected from the group consisting of water, methanol, ethanol, isopropanol, 1,3-propanediol, nitromethane, formic acid, acetic acid, ethylene glycol and glycerol.

6. The method according to claim 1, wherein the polar solvent is an aprotic polar solvent selected from the group consisting of acetone, ethyl acetate, acetonitrile, dimethyl sulfoxide, tetrahydrofurane and dimethylformamide.

7. The method according to claim 1, wherein the plurality of divalent ion-exchanging ions is derived from a salt selected from the group consisting of beryllium nitrate, beryllium iodide, beryllium bromide, beryllium chloride, magnesium nitrate, magnesium iodide, magnesium bromide, magnesium chloride, calcium nitrate, calcium iodide, calcium bromide, strontium nitrate, strontium chloride, strontium iodide, strontium bromide, barium nitrate, barium iodide, barium bromide, and barium chloride.

8. The method according to claim 1, wherein the substrate comprises a substantially alkali-free glass, glass-ceramic or ceramic.

9. The method according to claim 1, wherein during the step of treating the substrate, a greater number of divalent ion-exchanging ions enter the substrate than divalent exchangeable ions leave the substrate.

10. A method of treating a substrate, comprising the steps:
submersing a substrate having an outer region containing a plurality of divalent exchangeable ions in a bath that comprises a polar solvent and a plurality of divalent ion-exchanging ions, the substrate comprising a glass, glass-ceramic or ceramic;
pressurizing the bath to a predetermined pressure, wherein the predetermined pressure is substantially above ambient pressure;
heating the bath to a predetermined temperature, wherein the predetermined temperature is above ambient temperature; and
treating the substrate for a predetermined ion-exchange duration at the predetermined pressure and temperature such that a portion of the plurality of exchangeable ions is exchanged with a portion of the ion-exchanging ions, and
wherein the plurality of divalent exchangeable ions has a first valence and the plurality of divalent ion-exchanging ions has a second valence, the first valence being greater than or equal to the second valence.

11. The method according to claim 10, wherein the first valence is between 2 and 5.

12. The method according to claim 10, wherein the substrate comprises a substantially alkali-free glass, glass-ceramic or ceramic.

13. The method according to claim 10, wherein during the step of treating the substrate, a greater number of divalent ion-exchanging ions enter the substrate than divalent ion-exchangeable ions exit the substrate.

14. The method according to claim 10, wherein the predetermined pressure is approximately 10 MPa to 75 MPa.

15. The method according to claim 10, wherein the predetermined temperature is set at approximately 200° C. to 350° C.

16. The method according to claim 10, wherein the polar solvent is a protic polar solvent selected from the group consisting of water, methanol, ethanol, isopropanol, 1,3-propanediol, nitromethane, formic acid, acetic acid, ethylene glycol and glycerol.

17. The method according to claim 10, wherein the polar solvent is an aprotic polar solvent selected from the group consisting of acetone, ethyl acetate, acetonitrile, dimethyl sulfoxide, tetrahydrofurane and dimethylformamide.

18. The method according to claim 10, wherein the plurality of divalent ion-exchanging ions is derived from a salt selected from the group consisting of beryllium nitrate, beryllium iodide, beryllium bromide, beryllium chloride, magnesium nitrate, magnesium iodide, magnesium bromide, magnesium chloride, calcium nitrate, calcium iodide, calcium bromide, strontium nitrate, strontium chloride, strontium iodide, strontium bromide, barium nitrate, barium iodide, barium bromide, and barium chloride.

19. A method of treating a substrate, comprising the steps:
submersing a substrate having an outer region containing a plurality of divalent exchangeable ions in a bath that comprises a polar solvent and a plurality of divalent ion-exchanging ions, the substrate comprising a glass, glass-ceramic or ceramic;
pressurizing the bath to a predetermined pressure, wherein the predetermined pressure is substantially above ambient pressure;
heating the bath to a predetermined temperature, wherein the predetermined temperature is above ambient temperature; and
treating the substrate for a predetermined ion-exchange duration at the predetermined pressure and temperature such that a portion of the plurality of divalent exchangeable ions is exchanged with a portion of the divalent ion-exchanging ions,
wherein treating the substrate results in a greater number of divalent ion-exchanging ions entering the substrate than divalent exchangeable ions exiting the substrate.

20. The method according to claim 19, wherein the divalent exchangeable ions have a valence between 2 and 5.

21. The method according to claim 19, wherein a valence of the divalent exchangeable ions is greater than a valence of the divalent ion-exchanging ions.

22. The method according to claim 19, wherein the substrate comprises a substantially alkali-free glass, glass-ceramic or ceramic.

23. A strengthened article, comprising:
a substrate comprising (a) a glass, glass-ceramic or ceramic; (b) a compressive stress region that extends to a first depth in the substrate; and (c) a bulk concentration of divalent exchangeable ions,
wherein the compressive stress region has a concentration of divalent ion-exchanged ions, a concentration of divalent exchangeable ions and a compressive stress of at least 100 MPa, and
further wherein the concentration of divalent exchangeable ions in the compressive stress region is lower than the bulk concentration of divalent exchangeable ions.

24. The article according to claim 23, wherein the divalent exchangeable ions have a valence between 2 and 5.

25. The article according to claim 23, wherein the substrate comprises a substantially alkali-free glass, glass-ceramic or ceramic.

26. The article according to claim 23, wherein the divalent ion-exchanged ions are derived from a salt selected from the group consisting of beryllium nitrate, beryllium iodide, beryllium bromide, beryllium chloride, magnesium nitrate, magnesium iodide, magnesium bromide, magnesium chloride, calcium nitrate, calcium iodide, calcium bromide, strontium nitrate, strontium chloride, strontium iodide, strontium bromide, barium nitrate, barium iodide, barium bromide, and barium chloride.
